(19) United States
(12) Patent Application Publication
(10) Pub. No.: US 2016/0351062 A1
(43) Pub. Date: Dec. 1, 2016

(54) System and Method for the On-Demand Display of Information Graphics for Use in Facilitating Data Visualization

(71) Applicants: Arun Mathews, Midland, TX (US); Eleanor Lutz, Seattle, WA (US)

(72) Inventors: Arun Mathews, Midland, TX (US); Eleanor Lutz, Seattle, WA (US)

(21) Appl. No.: 14/720,948

(22) Filed: May 25, 2015

(51) Int. Cl. G09B 5/02; G06Q 20/14; G06Q 20/12; H04L 29/06

(52) U.S. Cl. CPC G09B 5/02; H04L 65/4084; G06Q 20/145; G06Q 20/1235

(57) ABSTRACT

A system and method for the acquisition of access to, and display of, information graphics on a computer processing device comprising a data interface, central processor unit, one or more input devices, storage, and memory. The electronic computing device is configured to display media content data to one or more users on demand. Media content is made accessible for download following successful completion of one or more payment transactions. Access to interactive media content, including animation having recursive action playback attributes, is made optionally available to users on a “pay-per-play” basis, thus providing efficiencies in the distribution of educational content. Access to viewing instances of information graphics playback may be constrained by a content provider according to a predetermined time period, a predetermine number of playback instances, or a predetermine subject matter associated with the media content.

### BACKGROUND OF THE INVENTION

Technical Field

The present invention relates generally to the electronic acquisition and display of information and more particularly, to systems and methods for providing interactive information graphic content to one or more users on an on-demand basis, to facilitate enhanced data visualization of information.

Description of Related Art

In the past, students and other individuals engaged in the process of learning were required to pour over textbooks having small print, requiring the reader to strain his or her eyes to review the content. For years, most textbooks incorporated solely text-based content, although some books featured static illustrations to depict the concepts taught therein. Many individuals found the delivery of educational content by such means to be less than engaging and in some instances, students experienced trouble learning complex concepts in this manner. Recently, as technology associated with the electronic arts has progressed, various electronic book (eBook) devices have been introduced that provide for the display of various media content to facilitate the learning process.

The use of eBooks to deliver educational or instructional content has many advantages. One advantage of utilizing eBook technology to deliver such educational content is that eBook devices, depending on their particular configuration, are capable of storing massive amounts of content in a single portable electronic device, thus providing a convenient alternative to carrying multiple heavy textbooks. Another advantage of utilizing eBook technology lies in the advantages inherent the eBook distribution model. Instead of being required to physically travel to a bookstore to purchase a textbook, or even order a hard copy of book from an online retainer, students can more conveniently download educational content directly to their eBook device over a communications network. Prior art eBook devices are capable of displaying educational content in various manners, including via text, video, audio, and through the use of other graphic images.

Data visualization involves techniques used to communicate data or information by encoding it as visual objects contained in graphics. Those of skill in the art will understand that a primary goal of data visualization is to communicate information clearly and effectively through graphical means. Those of skill in the art will also recognize that one means by which data visualization may be facilitated is through the use of information graphics to provide graphic visual representations of information, data or knowledge to facilitate the learning process. Examples of information graphics include charts, graphs, static illustrations, and animation.

While the incorporation of such information graphics to display educational content through eBook devices is known, there are many disadvantages and other drawbacks found in such prior art systems and methods for presenting such content. One disadvantage found in such prior art systems and methods of displaying information graphics is that substantially complex concepts are often difficult to grasp through the use of more traditional information graphics such as, for example, static images. Even if certain concepts may be eventually grasped by users using such static images, the manner in which the graphics are delivered to the user is inefficient and inconvenient. For example, should a user desire to watch a particular sequence of a linear animation in an attempt to grasp some complex concept being presented, the user of prior art eBook systems may be required to watch an entire animation sequence over and over again. If the user has the ability to control the playback of the animation, the user must inconveniently use an input device to stop the animation, and restart the animation at a desired point of playback. In short, prior art systems and methods for presenting complex educational content suffer drawbacks in that they are inefficient and cumbersome for users to utilize when it is necessary for the viewer to watch multiple instances of the particular graphic content.

Another drawback of prior art systems and methods for presenting educational content via an eBook is that in order to provide rich, meaningful educational content to users, substantial funds must typically be expended to create, produce and distribute such content. However, there is wide discrepancy in the learning abilities of students or other viewers of educational content. In fact, some students/viewers benefit more than other students/viewers from having access to information graphics when attempting to grasp complex educational concepts. While there may be some benefit to distributing the costs associated with creating, producing and delivering interactive information graphics evenly amongst all students/viewers, regardless of the helpfulness of such graphics to a particular student/viewer, the downside of such a distribution model is that the educational costs for some students is higher than it would have otherwise been had such funds not be expended on creating interactive content. It should be noted that for many students at numerous educational institutions, it is mandatory as condition of class participation, that they purchase the right to access educational content, whether by purchasing a traditional textbook or by purchasing access to digital education content. Therefore, a need that has not been met in the prior art heretofore, is a system and method for providing content-rich information graphics including, but not limited to, recursive animation (“looping” animation) playback attributes, to one or more users in an on-demand, as needed by a user, fashion.

These and other disadvantages found in the prior art are addressed and overcome in the systems and methods taught herein in connection with the present invention.

### BRIEF DESCRIPTION OF THE SEVERAL VIEWS OF THE DRAWINGS

The novel features believed characteristic of the invention are set forth in the appended claims. The invention itself, however, as well as a preferred mode of use, further advantages thereof, will be best understood by reference to the following detailed description of illustrative embodiments when read in conjunction with the accompanying drawings, wherein:

FIG. 1 is a block diagram illustrating exemplary components of an embodiment of the electronic book reader device (“eBook reader”);

FIG. 2 is a network diagram illustrating an exemplary network environment in which communications pathways between one or more eBook reader devices and one or more servers may be established;

FIG. 3 is a front view of an embodiment of the eBook reader device, illustrating a data interface for displaying text and information graphics to a user;

FIG. 4 is a front view of an embodiment of the eBook reader device, illustrating a data interface by which a user of said device may initiate a request to acquire access to one or more information graphics for display of the device;

FIG. 5 illustrates two views of an exemplary embodiment of an information graphic having recursive playback attributes, said graphic being associated with educational content from an e-textbook viewable on an eBook reader device; and

FIG. 6 is a flow diagram illustrating an embodiment of a process of a user acquiring access to view content on an embodiment of the eBook reader device.

Where used in the various figures of the drawings, the same reference numerals designate the same or similar parts. All figures are drawn for ease of explanation of the basic teachings of the invention only; the extensions of the figures with respect to number, position, relationship, and dimensions of the parts to form the preferred embodiment will either be explained or will be within the skill of persons of ordinary skill in the art after the following teachings of the present invention have been read and understood.

### DETAILED DESCRIPTION OF THE DRAWINGS

Several embodiments of Applicant's invention(s) will now be described with reference to the drawings. Unless otherwise noted, like elements will be identified by identical numbers throughout all figures. The invention(s) illustratively disclosed herein suitably may be practiced in the absence of any element that is not specifically disclosed herein.

Systems and methods for the display of media content in the form of text, audio, video and other information graphics, including, but not limited to, the display of such information graphics having recursive playback attributes, to facilitate data visualization, is disclosed herein. At the outset, it should be noted that while the embodiments discussed herein are associated with the delivery of information in the context of presenting educational content via a portable computer processing device, the concepts taught below could also be equally applied to providing any other type of information to one or more users via any type of computing device known or not yet known to those of skill in the art. By way of example, the teachings disclosed herein could be applied to the presentation of educational media content in a shared lecture experience delivered to participants through, for example, videoconferencing systems, social software, and web-based delivery systems. Other examples of possible applications of the teachings disclosed herein may include the demonstration of content via an audio book or podcast.

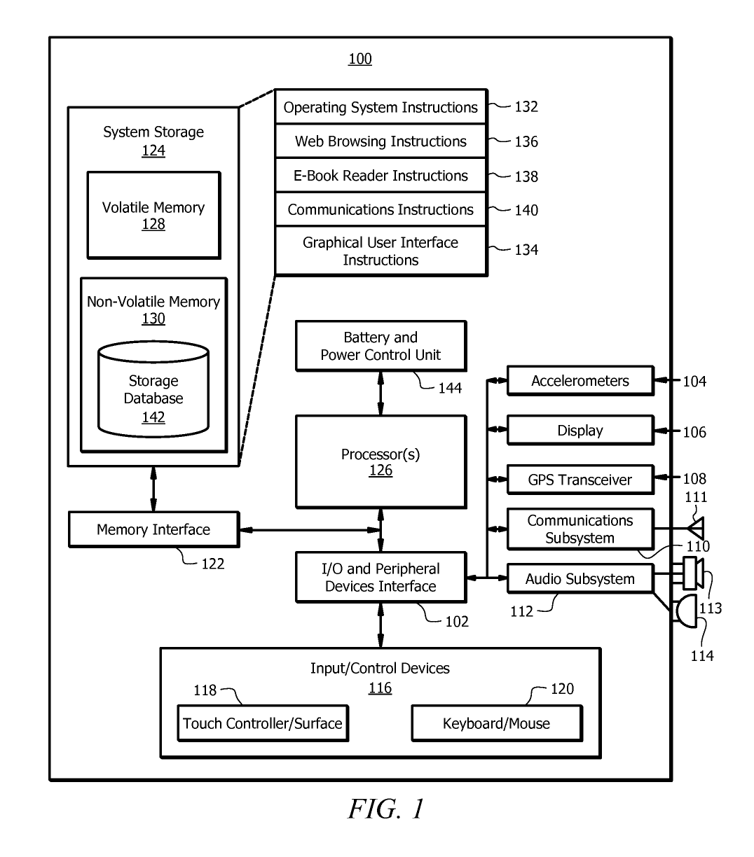

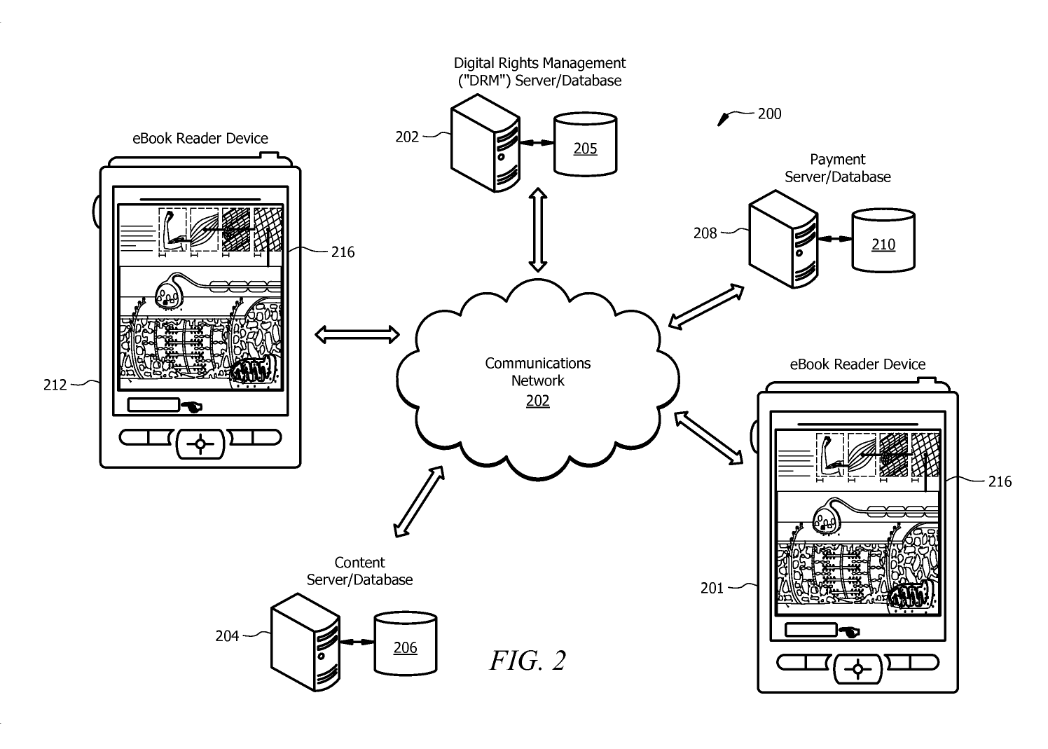

Referring now to FIG. 1, a block diagram illustrating exemplary components of an embodiment of the electronic book reader device (“eBook reader”) 100 as embodied in a portable wireless device. It should be noted that while the systems and methods disclosed herein are primarily taught within the context of implementation through a smart phone or electronic tablet as shown in FIG. 1, it is also contemplated that the systems and methods disclosed herein can also be implemented in any computer processing device for generating the features described in reference to FIGS. 2-6, including, but not limited to, portable or desktop computers, gaming consoles, and television systems. The eBook reader device can include system storage, memory interface, central processor unit(s), input/output (“I/O”) and peripheral devices interface. The foregoing electronic components can be separate components or can be integrated in one or more integrated components. The electronic components can be connected by one or more communication buses or signal lines.

Sensors, devices, and subsystems can be coupled to an I/O and peripheral device interface 102 to facilitate multiple functionalities. For example, accelerometers 104, a display(s) 106, global positioning system (“GPS”) transceiver 108, communications subsystem 110, and audio subsystem 112 can be connected to I/O and peripheral devices interface 102 to aid in driving, various functions of the device 100. For example, in some embodiments, the GPS transceiver 108 may be utilized to locate the position of the eBook 100 so as to provide a user with information regarding where nearby services may be offered (for example, tutoring, supplemental instruction, educational facilities, etc.). Further, in some embodiments, one or more accelerometers 104 can be utilized to detect the orientation of the device, allowing content to be displayed according to a detected orientation (e.g., portrait or landscape).

In one embodiment, a display 106 implemented in the eBook reader device may be utilized to facilitate the presentation of content in human-readable format to the one or more users of the device. Visual content may take the form of electronic books or other readable or viewable materials. In one embodiment, the display provides the text of the electronic books and further depicts any information graphics, illustrations, tables, videos, animations, or other graphic elements that may be stored in the eBook reader device, or are otherwise accessible to the eBook reader device by accessing external media content over a communications network. In one embodiment, the display may utilize various technologies such as LCD, Oxide LCD, a-Si, and TFT LCD display technologies to depict text and other information graphics in a high resolution rendering.

As discussed in further detail below, an embodiment of the eBook reader device is configured to deliver information and other media content, some of which will be interactive content, and some of which will be non-interactive content. Such interactive content may take the form of digital media assets such as text, audio, video, information graphics such as animation, and other forms of content that can be displayed on the eBook reader. As used herein, the term “interactive content” should be given its broadest possible construction but the scope of such construction should at least encompass content such as text, graphics, animation, audio, or video that is presented and/or can be manipulated in response to the actions of the user or viewer. Such actions may include the user utilizing a touch screen, mouse, keyboard, voice over a microphone, or some other input device to affect the behavior and/or presentation of the content. In the context of educational content presented via an embodiment of the eBook reader device, a user's actions can initiate/pause playback and determine the sequence in which instructional/educational media is displayed or otherwise presented.

Interactive content can comprise an array of digital media assets that can be created using various computer programming languages such as, for example, HTML5, XHTML, AJAZ, Java, and C#. At least one advantage of utilizing HTML5 language to author interactive media content and other content for display on embodiments of the eBook reader device, is that it requires less storage space and memory to implement. Other advantages of utilizing HTML5 language to author media content is that it provides for the display of such content by using functionality built in to device web browsers, without needing to utilize third-party plugin applications. HTML5 also provides an advantage in that it allows for more efficient offline caching of content, which can be critical to viewing such content if connectivity with a communications network is lost. In some embodiments, animated media content may be formatted for storage and playback in Graphics Interchange Format (“GIF”), which is easily created and compressed in relatively small file sizes, and are typically supported by most web browsers without the need for the installation of a plug-in. Authoring applications may also be utilized to create interactive content such as, for example, Adobe Edge Animate (Adobe, San Jose Calif.) and Adobe Captivate (Adobe, San Jose Calif.).

Functions related to communications can be facilitated through one or more communication subsystems 110 that can include one or more wireless or wired communication subsystems. Wireless communication subsystems can include radio frequency receivers and transmitters 111, and/or optical (e.g., infrared) receivers and transmitters. Wired communication systems can include a port device, e.g., a Universal Serial Bus (USB) port or some other wired port connection that can be used to establish a wired connection to other computing devices.

In one embodiment of the eBook reader device, an audio subsystem 112 can be coupled to a speaker 113 and one or more microphones 114 to provide voice-enabled functions, such as voice recognition, voice replication, digital recording, and telephony functions. In other embodiments of the eBook reader device, educational content in audio form may be delivered to one or more users via the audio subsystem and in particular, the speaker(s) 113.

Input/control devices 116 can include a touch controller and a touch surface 118, and/or other input controller(s) such as a keyboard and/or mouse 120. The touch controller can be coupled to the touch surface for directing and processing signals from the touch surface to the processor. A touch surface and touch controller 118 can, for example, detect contact and movement using any of a number of touch sensitivity technologies, including but not limited to capacitive and resistive technologies, as well as other proximity sensor arrays or other elements for ascertaining one or more points of contact with the touch surface. In one implementation, a touch surface can display a virtual keyboard 120, which can be used as an input/output device by the user. Other input controller(s) can be coupled to other input/control devices, such as one or more buttons, rocker switches, thumb-wheel, infrared port, USB port, and/or a pointer device such as a stylus (not shown).

In embodiments of the eBook reader device, a memory interface 122 can be coupled to system storage 124 and central processor unit(s) 126. System storage 124 may include volatile high-speed random access memory 128 or non-volatile memory 130. In one embodiment of the eBook reader device, the system storage may include storage media technologies such as RAM, ROM, EEPROM, flash memory or other memory technology, digital versatile disks (DVD) or other optical storage, magnetic disk storage, or any other medium which can be used to store desired information and which can be accessed by the eBook reader device.

The storage system may also store instructions to facilitate the operation of the eBook device, and communications with one or more additional computing devices, such as one or more eBooks, computers or servers. For example, operating system instructions 132 for the eBook reader device may be stored in the storage system. Operating system software such as iOS, Android, Darwin, RTXC, LINUX, UNIX, OS X, or WINDOWS may be used to facilitate operation of the eBook reader device. For example, operating system instructions may include instructions for handling basic system services and for performing hardware dependent tasks. One or more central processor units 126 are connected to the memory interface 122, which is in turn connected to the storage system. Such processor(s) may run or execute the operating system and various other software programs and/or sets of instructions stored in memory to perform various functions for the eBook reader device.

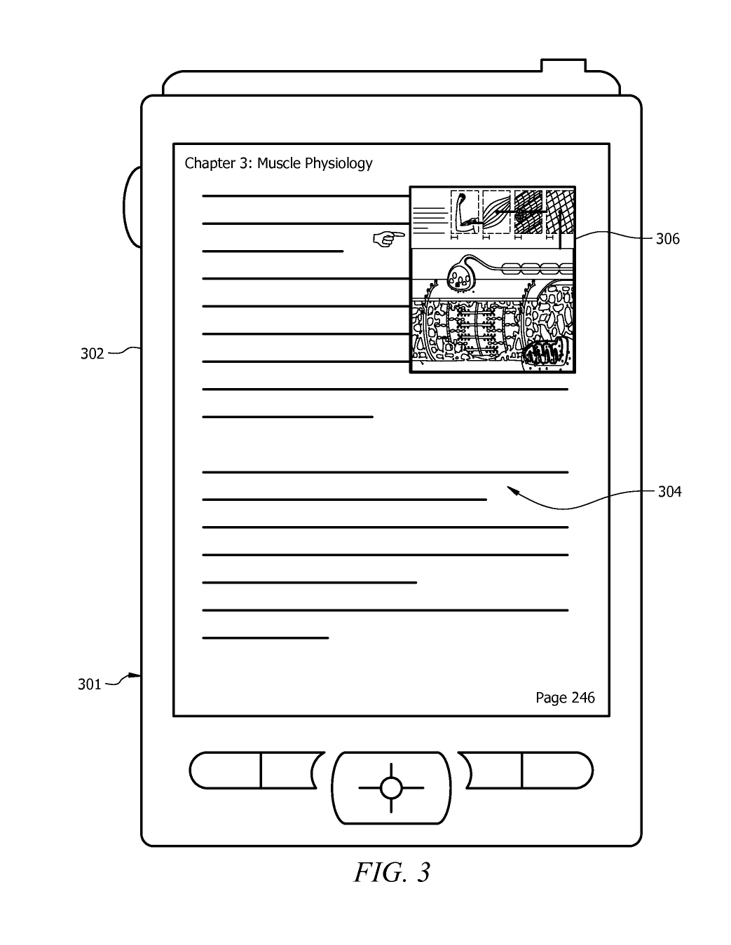

The storage system may include graphical user interface instructions 134 to facilitate graphic user interface processing, such as generating the GUIs shown in FIGS. 3-5; web browsing instructions 136 to facilitate web browsing-related processes and functions and display GUIs described in reference to FIGS. 3-5; communications instructions 140 for facilitating communications to and from the eBook reader device; and instructions for an eBook reader device application 138 that is capable of displaying GUIs, as described in reference to FIGS. 3-5. The storage system memory may also store other software instructions for facilitating other processes, features and applications, such as applications related to navigation, social networking, location-based services or map displays.

In an embodiment of the eBook reader device, the storage system may include one or more storage databases 132 stored preferably in non-volatile memory. Such databases may store information such as software, data associated with eBook media content, user account information associated with an account with a provider of media content, data associated with payment transactions and payment information, other user information, drivers, and/or any other data item utilized by the eBook reader device and servers taught herein. The databases may be managed by a database management system, for example hut not limited to, Oracle, DB2, Microsoft Access, Microsoft SQL Server, PostgreSQL, MySQL, FileMaker, etc.

In one embodiment, the eBook reader device further includes a power control unit and one or more batteries 144. The power control unit 144 is configured to control the amount of power consumed by the device. Those of skill in the art will recognize that by actively controlling the amount of power consumed by the eBook reader device, the device may achieve more efficient use of electrical energy that is consumed by the device. The power control unit may include a clock and/or timer for precise control of power consumed by the eBook reader device. The power control unit may include any combination of hardware and software, and digital and/or analog circuitry. The power control unit (also may be referred to or further include a battery management unit) may include one or more microcontrollers and/or other hardware modules. Embodiments of the eBook reader device may include one or more rechargeable batteries or other battery system for powering the device, including one or more batteries coupled together in parallel or series configuration to output any desired voltage and/or current. One or more batteries may be implemented by utilizing rechargeable battery chemistry including, but not limited to, nickel metal hydride (NiMH), lithium polymer, and lithium ion battery chemistries. In other embodiments of the device, the eBook reader may be supplied power via a wired power connection.

Referring now to FIG. 2, a network diagram illustrating an exemplary network environment in which communications pathways between one or more eBook reader devices and one or more servers may be established. As illustrated in FIG. 2, the eBook reader device is configured to establish communications links with a plurality of computer processing devices such as, for example, other eBook reader devices, as well as local and remote servers and associated databases that are configured to provide data and/or provide other services as discussed in further detail below. In one embodiment, and as discussed in further detail below, one or more eBook reader devices may also connect to other eBook reader devices of servers via a communications network 202.

The eBook reader device may be configured to communicate over any number of communications networks 202 for which it is configured. In one embodiment, the eBook reader device may be configured to operate over a global system for mobile communications (GSM) network, a GPRS network, an enhanced data GSM environment (EDGE) network, 802.x communication networks (e.g., WiFi, WiMax, or 3G networks), code division multiple access (CDMA) networks, and a Bluetooth™ network. The eBook reader device may also operate in a networked environment using logical connections to one or more remote computing devices. The remote computing processing devices may be a server, another eBook reader device, personal computer, smart phone, tablet computer, a router, a network PC, a peer device or other common network node, and typically includes many or all of the elements described above relative to the eBook reader. In certain embodiments, the network can include a communications network such as a local area network (LAN) or a wide area network (WAN). Such networking environments are commonplace in homes, offices, enterprise-wide computer networks, intranets, and the Internet.

When used in a WAN networking environment, the eBook reader typically includes a wireless network card, modem, Ethernet card, or other such means for establishing communications over the wide area network, such as the Internet, and is included within the communications subsystem 110 as discussed in connection with FIG. 1 discussed above. The wireless card, modem or other networking components, which may be internal or external, can be connected to the system bus via a network interface or adapter. When used in a LAN networking environment, the eBook reader may be connected to a local network through the network adapter.

In one embodiment, the eBook reader device may establish a communications link with a digital rights management (“DRM”) server 202, configured to control the electronic distribution and access to media content (such as educational content). It should be noted herein that although the various servers discussed herein are shown and described with reference to FIG. 2 as being separate and distinct servers (and separate associated databases), it is fully contemplated that in other embodiments, all functions provided by separate servers as discussed herein, may alternatively be provided by a single server or fewer servers or other computer processing device(s).

A data interface, presented via a website accessible by the user through a web browser, or a dedicated electronic media store or some other electronic distribution channel (for example, Apple iTunes, Google Play, and Amazon.com), may be provided by or associated with the DRM server, providing users with the ability to search for and to purchase access to educational or other media content selected by the user for viewing on the eBook reader device. The eBook reader device may communicate with the DRM server to establish a user account. The DRM server account activation process may utilize a username/email and password identification method for authenticating access by a user to the DRM server system. In other embodiments, other forms of identity authentication, such as security cards and/or digital certificates may be utilized. For example, a user may be able to specify and/or obtain a login ID during an account activation process with the DRM server. In other embodiments of the eBook reader device, access to educational content may be subscription based such that the user of the device must make periodic payments to continue accessing content. In such an embodiment, the eBook reader device may be configured to first access the DRM server to authenticate the user's right to continued access to the content, before accessing said content.

In one embodiment, an account is created and associated with an eBook reader device user prior to the user downloading or otherwise accessing the media content. User payment information such as credit card billing information, may be stored on a payment database 210 that is coupled to a payment server 208. The payment server is configured to establish a communications link with the DRM server and/or eBook reader device in order to initiate payment transactions that may be required as a condition of the user accessing media content. Payment transactions may be configured to occur during various points in the access acquisition process of the user seeking access to media content. In one embodiment, the eBook reader will initiate a communications link with the payment server (or alternatively, a communications link will be established between the DRM server and the payment server) at the time full or limited access to media content data is sought and approved by the DRM server. For example, in one scenario, the user of the eBook device reader will seek to download or have access to a portion or all of the content data associated with an e-textbook. In one embodiment, a portion of content data associated with an e-textbook may include all text and static illustrations associated with the e-textbook. In one embodiment, all content data associated with an e-textbook may include all text, static illustrations, videos, linear animations, recursive animations, and any other information graphics created in association with the e-textbook and available to be accessed by users.

In one embodiment of the eBook reader device, as discussed further below, the device may be configured to provide access to certain media content on an “on-demand” or “pay-per-access” basis. For example, a user may initially pay for and receive, limited access to content data that includes, for example, solely text-based content. The eBook reader device will embed an image, symbol, or some other indicator displayed on the GUI of the device (preferably adjacent to text or other illustrations associated with certain educational content) that further media content, including interactive media content, is available for the user to access for a particular topic being addressed in the content data that is already accessible to the user.

In one embodiment, an animation having recursive action (“looping” animation) playback attributes associated with a particular educational topic may be available for viewing by a user. An input device will be provided to the user to select such animation by, for example, using a finger to touch a static image of the animation displayed on the eBook. Unless the user has already acquired access rights to view such animation, a user's selection of the image will cause a communication link to be established with the DRM server to initiate the acquisition of access to such animation. In such a scenario, the user will be given an opportunity to pay for access to the animation by establishing a communications link with the payment server. In other embodiments, the user will seek and acquire prior authorization to initiate a payment transaction for any future access to additional media content data sought by the user.

In one embodiment, upon receiving authorization from the DRM server to download or otherwise access media content, a communications link will be established with a content server which is connected to a content database configured to store content data. A signal will be transmitted from the DRM server to the media content server, acknowledging that the user has been granted access to particular media content. In one embodiment, one or more content data files will then be transmitted to an authorized eBook device for viewing. The eBook reader device is configured with one or more data interfaces configured to present such content data files to a user via a dedicated eBook software application or alternatively, by utilizing a web browser. It is contemplated that other data interfaces may be utilized to present media content data to user(s) of the eBook reader device.

In various embodiments, the granting of access to one or more information graphics may be limited in a variety of ways, all of which are contemplated herein. In one embodiment, a content provider may provide a user with the ability to acquire access to view a single information graphic (for example, a recursive animation) with views not limited by any predetermined time period or predetermined instances of playback of the graphic. In other embodiments, the content provider may provide a user with the ability to acquire access to view one or more information graphics for a limited predetermine time period, limited predetermined number of instances of playback, or some other predetermined quantitative constraint on access to the media content. In some embodiments, a playback counter routine may be implemented via software within the eBook Reader instructions or elsewhere (other software running within the eBook device or at the DRM server, content server, or payment server). The aforesaid playback counter routine, at least in one embodiment, would count the number of instances in which the eBook device user viewed/played back a particular information graphic (or set of information graphics), which could then be transmitted to the DRM server or payment server for further processing of payment related information. In other embodiments, a content provider may provide a user with the ability to acquire access to one or more information graphics associated with a particular topic, e-textbook chapter, e-textbook section, or other constraint based on subject matter of the media content. In even further embodiments, a content provider may limit access to viewing one or more information graphics by requiring the user to pay some amount for each and every instance of viewing or playback for said one or more instances of information graphic playbacks.

In even further embodiments, the content provider may permit a user to purchase “bundles” (a predetermined number of a plurality of instances of viewing or playback) of access rights to view one or more information graphics associated with media content data related to the same discrete media content (for example, an e-textbook), or even multiple different discrete media content (for example, multiple e-textbooks). Acquisition of access by a user may be accomplished through the eBook reader device by establishing a communications link with the DRM server each time access for a particular information graphic or other information is sought or alternatively, access may be sought and approved by the DRM server beforehand (before the viewing of the particular instance(s) of playback) such that a communication link need not be established between the eBook and DRM server each time playback is sought. In such a circumstance, the DRM server will transmit information to the media content server/database, acknowledging that a particular user has access to certain data, and identifying the amount of such access, and any related constraints on such access (for example, time period constraints, subject matter constraints, and constraints related to instances of playback/viewing).

Still referring to FIG. 2, in some embodiments, eBook reader devices are configured to communicate with one another over a communications network. For example, in one embodiment, a first eBook 201 device may establish a communications link with a second eBook 212 device in order to more effectively discuss aspects of the media content data that is being presented on the eBook reader device(s). Should the user of one eBook reader device 201 have a question pertaining to a particular information graphic, such user may utilize an input device (touch screen, mouse, keyboard, etc.) to annotate the graphic 214. A communications link may be established between the first eBook reader device 201 and a second eBook reader device 212. A data file containing the annotated graphic and other information regarding the graphic and user of the first eBook (title of book from which it was taken, page number, unique identifier associated with user, date/time information) may be transmitted to the second eBook 212. Depending on the scope of access granted by the content provider, the user of the second eBook reader device may then be permitted to view the annotated graphic data 216, and use the communications functionality (voice, text, email, etc.) to communicate with the user of the first eBook reader device regarding the graphic.

In other embodiments, the provider of the content may choose to require such a second eBook user to have also properly acquired rights to view the annotated graphic prior to viewing such graphic. In such a circumstance, the second user, if access rights have not already been acquired, will be invited to acquire such access rights to view the annotated graphic. To acquire such access rights, a communication link will be established between the second eBook reader device and the DRM server, requesting access rights to such content. In even further alternate embodiments, such communications links may be established between more than two eBooks so as to facilitate discussions about educational media content data amongst larger groups such as, for example, entire classes of students. In such embodiments, the content provider may give one or more persons (for example, a teacher or professor) the ability to grant limited access to all or a portion of educational media content for a limited time period so as to be able to effectively discuss certain aspects of the content without the need for each and every user having to acquire access to view said content.

Referring now to FIG. 3, a front view of an embodiment of the eBook reader device 301, illustrating a data interface 302 for displaying text and information graphics to a user. In one embodiment, the data interface comprises a GUI presented on a display of the device, the GUI being a web browser configured for displaying HTML5 media content data. Media content data may include text 304, videos (not shown), audio, images 306, and other media content known in the art. In one embodiment, a text 304 passage from a chapter of an e-textbook is displayed on a GUI. An image 306 intended to illustrate a concept being taught in the passage is nested into the GUI so as to be displayed to a user. A recursive animation associated with the image 306 such that a user may use an input device (such as a finger 308 on a touch screen) to select the image for playback as the recursive animation. As previously discussed, such selection will cause the eBook reader device to establish a communications link with the DRM server to confirm authorization to access the animation file. In some embodiments, such authorization is pre-acquired, meaning that any such access rights are stored within a database stored on the eBook reader such that an external communications link need not be established each time the eBook reader needs to ascertain access rights to a particular content data file. In either scenario, once access rights are confirmed, the animation or other information graphics data will be available for viewing by the user after establishing a communications link with the media content server.

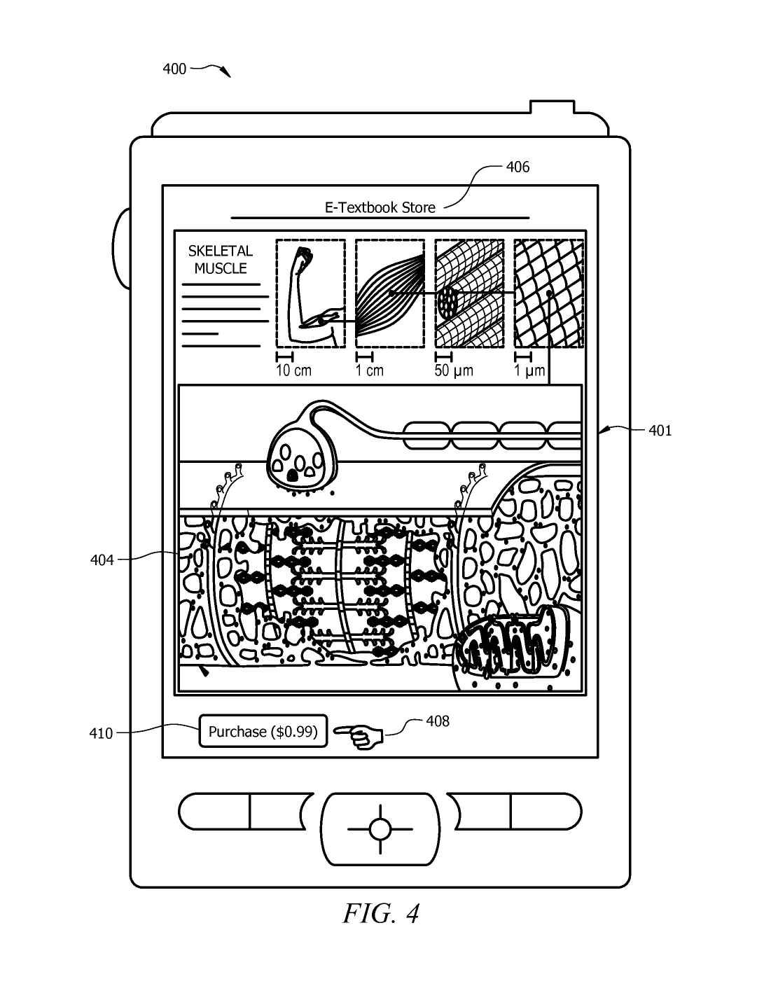

Referring now to FIG. 4, a front view of an embodiment of the eBook reader device 400, illustrating a data interface 401 by which a user of said device may acquire access to one or more information graphics for display of the device. In one embodiment, following a user's selection of an information graphic as discussed above with reference to FIG. 3, a communications link will be established with the DRM server. A data interface 401 such as a web browser will then display content associated with, for example, an online e-textbook store 406. Although not explicitly shown separately in FIG. 2, a communications link may be established between the eBook and a separate web server in order to access and view media content. In certain embodiments, the media content server acts as such a web server. The web browser will display an image of the information graphic 404 selected by the user for viewing. The user will be given the opportunity to purchase access to the recursive animation associated with the image by using an input device 408 to indicate the user's willingness to purchase access. If payment has not already been made, the DRM server (or eBook device) will establish a communications link with the payment server to initiate and complete a payment transaction prior to the user acquiring access to the animation. Following payment transaction completion, the payment server will transmit a signal to the DRM server, acknowledging payment, which will in turn cause the DRM server to transmit a signal to the content server, permitting the eBook to download or otherwise access the selected media content data.

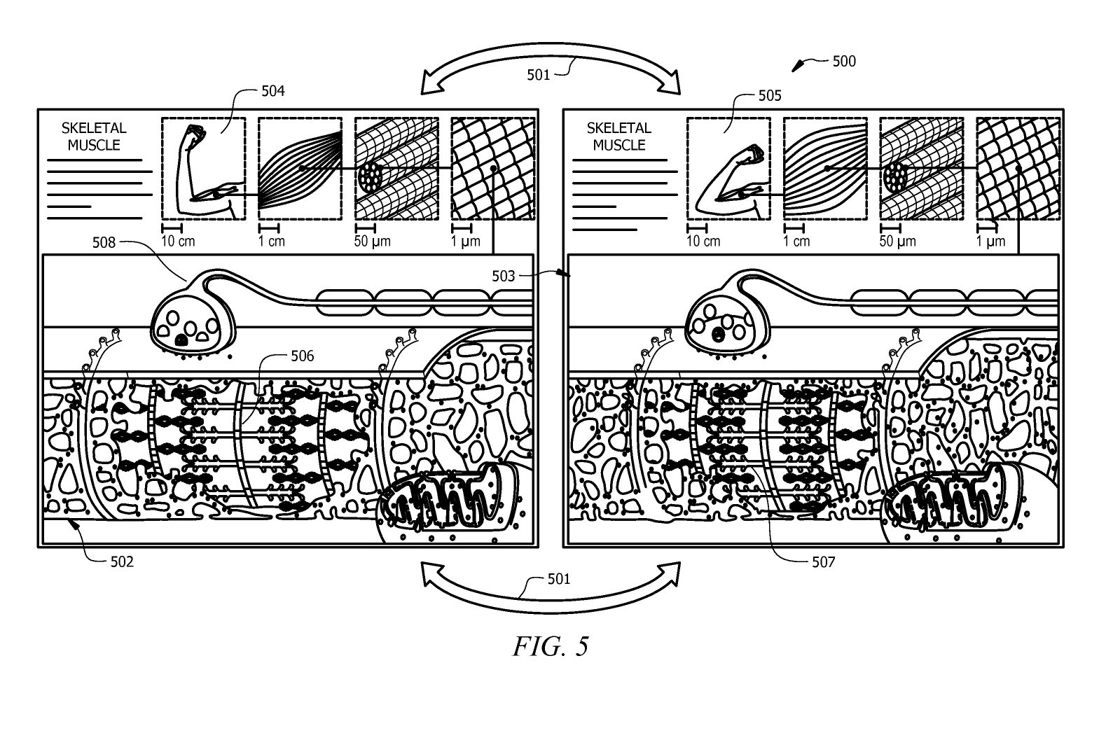

Referring now to FIG. 5, which illustrates two views of an exemplary embodiment of a recursive animation associated with educational content from an e-textbook viewable on an eBook reader device. As used herein, the term “recursive animation” or “animation having recursive action playback attributes” refers to looping animation in which an animation, typically of relatively short duration, proceeds from start to finish in linear fashion but when a playback sequence of the animation is completed, the animation automatically starts over from the beginning of the sequence. In this manner, the animation “loops” 501 until action is taken to halt the animation (via an input device or sequence times out after a predetermined period of inactivity). An advantage of such recursive animation over traditional linear animation (once the playback sequence has completed, a user must initiate playback to once again view the animation) is that the animation can easily be view multiple times by a viewer without it being necessary to take action each time a successive playback is desired.

In the embodiments of the views shown in FIG. 5, a first animation view 502 is displayed to a user, followed by a second animation view 503. As the animation sequence loops, various aspects of the information graphics displayed facilitate data visualization. For example, in the images shown, various aspects of muscle physiology 504, 505 and associated biochemical processes 506, 507 are shown in looping animated sequence, allowing the user to carefully study the processes and changes involved. In one embodiment, labels 508, annotations, and further descriptive content shown on or adjacent to the animation provide the user with additional educational content regarding the concepts being taught via the information graphics.

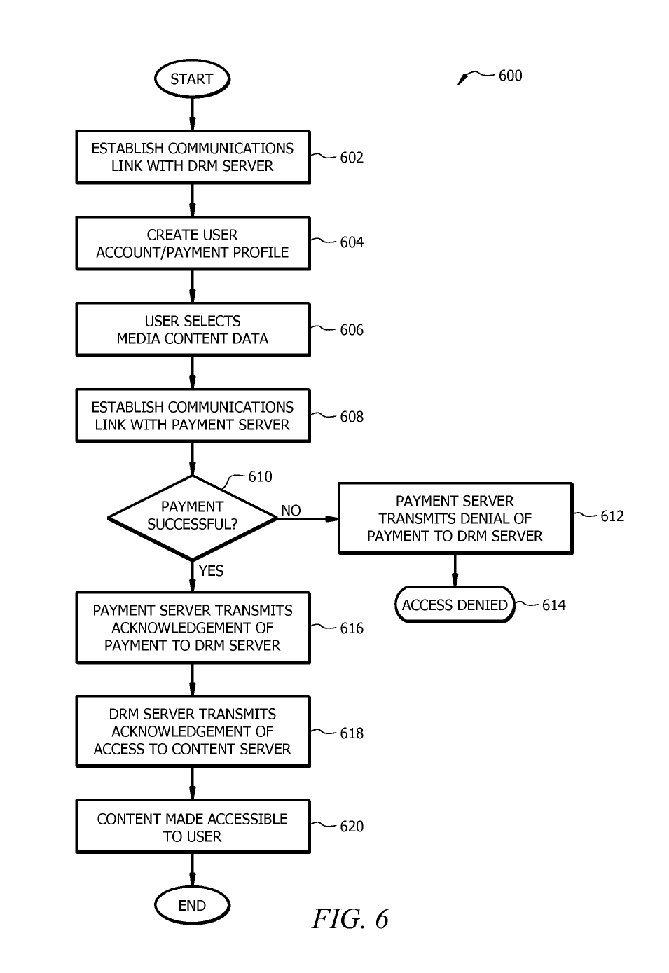

Referring now to FIG. 6, a flow diagram illustrating an embodiment of a process 600 of a user acquiring access to view content on an embodiment of the eBook reader device. In one embodiment, a process for acquiring access to view one or more media content data files is initiated by an eBook establishing 602 a communications link, via a communications network, to a DRM server, which is configured to control access to media content data. Using a data interface, an eBook user will be guided through a process for establishing 604 an account with a provider of media content such as, for example, educational content. The establishment of a user account will require the user to provide, among other things, identifying information regarding the user (name, educational courses, educational institution, contact information) and payment information (credit card, debit card, payment voucher, coupons, gift certificates, etc.). Following the creation of a user account, a user will be invited to browse selections of educational media content. The user will be given an option to view particular e-textbooks and other content associated with his or her identified educational courses at his or her identified educational institution. Selected excerpts of or previews of the media content may be provided to the user via a data interface. Search functionality is also preferably provided to the user, allowing the user to search for educational content using a keyword search, or by providing the user with a hierarchical selection tree using, for example, drop down menus to further narrow a user's search. The user may then select 606 one or more educational media content data files for later viewing.

Referring still to FIG. 6, after selecting one or more educational media content data files, a communications link will be established with the payment server to initiate a payment transaction. Utilizing the payment information provided by the user, the payment server will initiate a payment transaction by communicating with various credit card and other banking institutions to complete payment. If payment is not successful 610, the payment server will transmit data to the DRM server, indicating that payment was denied 612, resulting in the denial of access 614 to the media content data. If payment is successful, the payment server transmits 616 a signal to the DRM server, acknowledging a successful payment. In some embodiments, a media content provider (or other entity in a chain of distribution of the media content) may initiate one or more payment transactions with one or more creators (or banking/payment gateway associated with such creator(s)) of a particular information graphic (or set of information graphics) upon the media content provider receiving notification that the particular information graphic (or set of information graphics) has been viewed by end users. In such embodiments, an amount of payment from the media content provider (or other entity in a chain of distribution of the media content) to the one or more creators (or banking/payment gateway associated with such creator(s)) of the particular information graphic (or set of information graphic) may be based on the total number of times the particular information graphic (or set of information graphics) is viewed by user(s) of an eBook reader device. Information pertaining to a number of total viewing instances/playbacks may be collected via the aforementioned playback counter routine and transmitted to one or more appropriate servers (for example, a DRM server or payment server) for usage in determining the amount of payment(s) to be made to media content provider(s) and media content creator(s). In one embodiment, examples of media content creators include artists and animators, or entities employing or contracting with such persons for the creation of media content. In one embodiment, the amount of payment(s) to be made to a media content creator(s) may be calculated based on a predetermined monetary rate per the total viewing instances/playbacks initiated by users. Subsequently, the DRM server transmits 618 a signal to the content server, acknowledging that access has been granted to the user to access the selected media content data. The media content data is then made accessible 620 to the user for download or to otherwise access.

It should be noted that the description of the present invention has been presented for purposes of illustration and description, and is not intended to be exhaustive or limited to the invention in the form disclosed. Many modifications and variations will be apparent to those of ordinary skill in the art. The preferred embodiment appearing in the drawings was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims. Moreover, it should be noted that uses of the phrase “the present invention” within this disclosure are not intended to limit or otherwise restrict the scope of the invention(s) disclosed and claimed by the inventor, but said phrase is merely intended to refer to certain examples of embodiments of the invention(s).

What is claimed is:

1. A system for providing access to one or more instances of media content to a user on an on-demand basis, said system comprising:
(a) a first computer processing device having at least one display;
(b) a second computer processing device; and
(c) a communications network over which said first computer processing device may communicate with said second computer processing device,
wherein said first computer processing device is configured to establish, via said communications network, a communications link with said second computer processing device, to transmit to said second computer processing device, a request to access one or more instances of media content playback, said request being initiated by said user,
wherein said upon receiving said request, said second computer processing device initiates one or more payment transactions associated with said user's request,
wherein if said one or more payment transactions are successfully completed, said one or more instances of media playback are made available for access by said first computer processing device.

2. The system of claim 1 wherein said one or more instances of media content playback comprises one or more instances of information graphics having recursive action playback attributes.

3. The system of claim 2 wherein said access to said one or more instances of information graphics having recursive action playback attributes is constrained by a predetermined time period.

4. The system of claim 2 wherein said access to said one or more instances of information graphics having recursive action playback attributes is constrained by a subject matter associated with said media content.

5. The system of claim 2 wherein said access to said one or more instances of information graphics having recursive action playback attributes is constrained by a predetermined number of instances of playback for which access is requested by said user.

6. The system of claim 2 wherein each time said one or more instances of information graphics having recursive action playback attributes is requested to be viewed by a user, a communication link is established between said first computer processing device and said second company processing to initiate a payment transaction.

7. The system of claim 2 wherein said first computer processing device further comprises one or more input control devices by which said user may select for viewing on said display, said one or more instances of information graphics having recursive action playback attributes.

8. The system of claim 2 wherein said first computer processing device is capable of establishing a communications link with a third computer processing device having a display, wherein annotated images associated with said one or more instances of information graphics having recursive action playback attributes may be transmitted from said first computer processing device to said second computer processing device over said communications network.

9. The system of claim 2 wherein said second computer processing device is capable of providing access to view said one or more instances of information graphics having recursive action playback attributes, to a plurality of persons for a predetermined time period.

10. The system of claim 2 wherein said second computer processing device is capable of providing access to view said one or more instances of information graphics having recursive action playback attributes, to a plurality of persons associated with an educational institution, without each such person initiating a payment transaction to acquire such access.

11. A method for acquiring access to, and displaying, media content on an on-demand basis, said method at least partially executed on a tangible non-transitory computer usable medium having computer readable program code means embodied therein for causing a computer device to execute one or more steps of said method, said method comprising the steps of:
(a) establishing a communications link, over a communications network, between a first computer processing device having a display, and a second computer processing device;
(b) sending a request, by said first computer processing device, for access to view one or more instances of media content playback, said request being transmitted to a second computer processing device over said communications link;
(c) initiating, by said second computer processing device, one or more payment transactions associated with said request for access to view one or more instances of media content playback; and
(d) authorizing access, by said second computer processing device, to view said one or more instances of media content playback on said first computer processing device if said one or more payment transactions are successfully completed.

12. The method of claim 11 wherein said one or more instances of media content playback comprises one or more instances of information graphics having recursive action playback attributes.

13. The method of claim 12 wherein said access to said one or more instances of information graphics having recursive action playback attributes is constrained by a predetermined time period.

14. The method of claim 12 wherein said access to said one or more instances of information graphics having recursive action playback attributes is constrained by a subject matter associated with said media content.

15. The method of claim 12 wherein said access to said one or more instances of information graphics having recursive action playback attributes is constrained by a predetermined number of instances of playback for which access is requested by said user.

16. The method of claim 12 wherein each time said one or more instances of information graphics having recursive action playback attributes is requested to be viewed by a user, a communications link is established between said first computer processing device and said second company processing to initiate a payment transaction.

17. The method of claim 12 wherein said first computer processing device further comprises one or more input control devices by which said user may select for viewing on said display, said one or more instances of information graphics having recursive action playback attributes.

18. The method of claim 12 wherein said first computer processing device is capable of establishing a communications link with a third computer processing device having a display, wherein annotated images associated with said one or more instances of information graphics having recursive action playback attributes, may be transmitted from said first computer processing device to said second computer processing device over said communications network.

19. The method of claim 12 wherein said second computer processing device is capable of providing access to view said one or more instances of information graphics having recursive action playback attributes, to a plurality of persons for a predetermined time period.

20. The method of claim 12 wherein said second computer processing device is capable of providing access to view said one or more instances of information graphics having recursive action playback attributes, to a plurality of persons associated with an educational institution, without each such person initiating a payment transaction to acquire such access.
